(19) United States
(12) Patent Application Publication
(10) Pub. No.: US 2025/0379233 A1
(43) Pub. Date: Dec. 11, 2025

(54) POLAR OR IONIC POLYMER FOR SULFUR CATHODE OF LITHIUM-SULFUR BATTERY AND PREPARING SULFUR CATHODE OF LITHIUM-SULFUR BATTERY USING THE SAME

(71) Applicant: UIF (UNIVERSITY INDUSTRY FOUNDATION), YONSEI UNIVERSITY, Seoul (KR)

(72) Inventors: Sang-Young LEE, Seoul (KR); Myeong-Hwa RYOU, Seoul (KR); Hyunseok MOON, Seoul (KR)

(73) Assignee: UIF (UNIVERSITY INDUSTRY FOUNDATION), YONSEI UNIVERSITY, Seoul (KR)

(21) Appl. No.: 19/229,585

(22) Filed: Jun. 5, 2025

(30) Foreign Application Priority Data
Jun. 5, 2024 (KR) 10-2024-0073601
Jun. 4, 2025 (KR) 10-2025-0072723

(51) Int. Cl. H01M 4/62; H01M 4/02; H01M 4/04; H01M 4/1397; H01M 4/58; H01M 10/052

(52) U.S. Cl. CPC H01M 4/622; H01M 4/0404; H01M 4/1397; H01M 4/5815; H01M 10/052; H01M 2004/028

(57) ABSTRACT

The present invention relates to a binder composition for a sulfur cathode of a lithium-sulfur secondary battery, comprising at least one selected from a polar monomer, an ionic monomer, a polar polymer, and an ionic polymer, and comprising a counterion that forms a pair with an ion included in the ionic monomer and the ionic polymer; and to a sulfur cathode and a lithium-sulfur secondary battery comprising the same. Accordingly, the shuttle phenomenon of lithium polysulfide can be prevented, and the formation of a three-dimensional lithium sulfide structure on the surface of the sulfur cathode can be induced, thereby preventing the loss of active material and suppressing passivation of the sulfur cathode surface, ultimately enabling the realization of a high energy density lithium-sulfur secondary battery.

### CROSS-REFERENCE TO RELATED APPLICATION

This application claims priority to Korean Patent Application No. 10-2024-0073601 filed on Jun. 5, 2024 and Korean Patent Application No. 10-2025-0072723 filed on Jun. 4, 2025 and all the benefits accruing therefrom under 35 U.S.C. § 119, the contents of which are incorporated by reference in their entirety.

### BACKGROUND

Lithium secondary batteries are used in various fields such as electric vehicles (EV), vacuum cleaners, electric bicycles, various robots, and large-scale energy storage systems (ESS). Since the cathode and anode materials of the lithium secondary battery determine the capacity of the battery, the lithium secondary battery has a limitation in capacity due to the material limitations of the cathode and anode. In particular, secondary batteries used in electric vehicles must be usable for a long time after a single charge, so the discharge capacity is very important. In order to solve the capacity limitation of lithium secondary batteries, it is required to develop a new concept of secondary battery that goes beyond the conventional secondary battery principles.

The lithium-sulfur secondary battery is a new high-capacity, low-cost battery system that can overcome the capacity limitation determined by the intercalation-deintercalation reaction of lithium ions into the layered structure of metal oxides and graphite, which is the basic principle of lithium-ion batteries, and can also enable replacement of transition metals and cost reduction. The sulfur cathode not only has a high theoretical capacity (1,675 mAh/g) but also has excellent price competitiveness due to the abundance of sulfur resources, so lithium-sulfur secondary batteries are attracting attention as next-generation batteries. However, in lithium-sulfur secondary batteries, lithium polysulfide (Li₂Sₙ, 4≤n≤8), which is an intermediate product generated during electrochemical reactions, dissolves in the organic liquid electrolyte that serves as the medium for lithium ion movement, causing the polysulfide shuttle phenomenon. Such a polysulfide shuttle phenomenon leads to loss of active material and deterioration of battery performance, making commercialization difficult. In particular, due to the low electronic conductivity of lithium sulfide (Li₂S), which is the final discharge product of the lithium-sulfur secondary battery, there is a problem that the surface of the sulfur cathode becomes passivated.

Therefore, in order to commercialize lithium-sulfur secondary batteries, it is necessary to develop a technology that can effectively suppress the polysulfide (Li₂Sₙ, 4≤n≤8) shuttle phenomenon and, at the same time, prevent the passivation of the sulfur cathode surface by lithium sulfide (Li₂S). Typically, the polymer binder of the sulfur cathode is used to secure the adhesion between the electrode active material and the current collector, and research related to the prevention of the polysulfide shuttle phenomenon, which is a major challenge of the sulfur cathode, or the control of the morphology of the lithium sulfide deposition layer, which is the final discharge product, has rarely been conducted.

### SUMMARY

The object of the present invention is to solve the above problems, and provides a binder composition for a sulfur cathode of a lithium-sulfur secondary battery, in which the binder component of the sulfur cathode exhibits electrostatic interaction with lithium polysulfide through an ion dipole interaction-based polar-ionic binder design, thereby suppressing the shuttle phenomenon and inducing a three-dimensional morphology of lithium sulfide, the final discharge product, on the surface of the sulfur cathode; a sulfur cathode having high specific capacity and cycle life characteristics using the same; and a high energy density lithium-sulfur secondary battery comprising the same.

The objects of the present invention are not limited to the above-mentioned purposes, and other objectives and advantages of the present invention not mentioned can be understood through the following description and will be more clearly understood through the embodiments of the present invention. In addition, it will be easily understood that the objects and advantages of the present invention can be realized by the means and combinations thereof described in the specification

In order to solve the above problems, the present invention provides a binder composition for a sulfur cathode of a lithium-sulfur secondary battery, comprising at least one selected from ionic monomers, ionic polymers, polar monomers, and polar polymers, and comprising a counterion that forms a pair with the ion included in the ionic monomer and the ionic polymer.

In one embodiment of the present invention, the ionic monomer or ionic polymer includes a cationic group and a counter anion that forms a pair with the cationic group, wherein the cationic group is any one selected from the group consisting of an ammonium group, an imidazolium group, a pyridinium group, a phosphonium group, a sulfonium group, a pyrrolidinium group, a guanidinium group, an isothiouronium group, a thiouronium group, a pyrimidinium group, a methanium group, and a morpholinium group; and the counter anion may be any one selected from the group consisting of NO₃⁻, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₇⁻, CF₃CO₂⁻, CF₃SO₃⁻, N(SO₂CF₃)₂⁻ (TFSI⁻), N(COCF₃)(SO₂CF₃)⁻, N(SO₂F)₂⁻, N(CN)₂, C(CN)₃⁻, SCN⁻, SeCN⁻, CuCl₂⁻, and AlCl₄⁻.

In one embodiment of the present invention, the cationic group may be a conjugate base of a soft acid, and the counter anion may be an anion which is a conjugate acid of a hard base, forming a combination of SAHB type (Soft Acid-Hard Base).

In one embodiment of the present invention, the ionic monomer may be an ionic monomer comprising an ammonium group represented by the following Structural Formula 1.

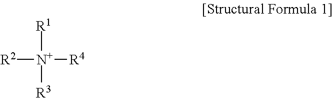

In Structural Formula 1,
R¹ to R⁴ are each independently a C1 to C10 alkyl group or a C2 to C10 alkenyl group.

In one embodiment of the present invention, the ionic monomer represented by Structural Formula 1 may be represented by the following Structural Formula 1-1.

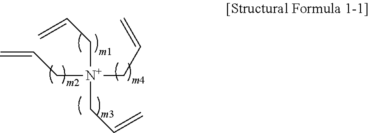

In Structural Formula 1-1,
m1 to m4 are the number of repeating units, and are each independently an integer from 1 to 10.

In one embodiment of the present invention, the ionic monomer and its counter anion may be tetraallyl ammonium and nitrate ion (NO₃⁻) represented by the following Chemical Formula 1.

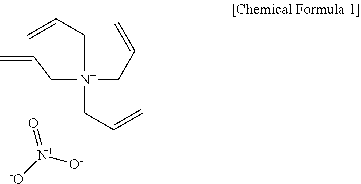

In one embodiment of the present invention, the ionic polymer may be a polymer of the ionic monomer or a graft polymer comprising the ionic monomer.

In one embodiment of the present invention, the ionic polymer may include one or more ammonium groups represented by the following Structural Formula 2 in the main chain, and the counter anion that forms a pair with the ammonium group may be an anion which is a conjugate acid of a hard base.

### [Structural Formula 2]

In Structural Formula 2,
R⁵ and R⁶ are each independently a C1 to C10 alkyl group or a C2 to C10 alkenyl group.

In one embodiment of the present invention, the binder composition for the sulfur cathode of the lithium-sulfur secondary battery may further include a crosslinking monomer.

In one embodiment of the present invention, the crosslinking monomer may be any one selected from the group consisting of ETPTA (ethoxylated trimethylolpropane triacrylate), TMPTA (trimethylolpropane triacrylate), di(trimethylolpropane) tetraacrylate, diethylene glycol diacrylate, diethylene glycol dimethacrylate, ethylene glycol dimethacrylate, dipropylene glycol dimethacrylate, ethylene glycol divinyl ether, diethylene glycol divinyl ether, triethylene glycol dimethacrylate, dipentaerythritol pentaacrylate, trimethylolpropane, trimethylolpropane trimethacrylate, propoxylated trimethylolpropane triacrylate, trimethylolpropane triacrylate, PETA (pentaerythritol triacrylate), PEGDA (poly(ethylene glycol) diacrylate), PEGDMA (poly(ethylene glycol) dimethacrylate), PPGDA (poly(propylene glycol) diacrylate), and PPGDMA (poly(propylene glycol) dimethacrylate).

In one embodiment of the present invention, the binder composition for the sulfur cathode of the lithium-sulfur secondary battery may further include a linear polymer.

In one embodiment of the present invention, the linear polymer may be any one selected from the group consisting of polyvinylpyrrolidone (PVP), polyvinylidene fluoride (PVDF), polytetrafluoroethylene (PTFE), carboxymethylcellulose (CMC), polyvinyl alcohol (PVA), polyvinyl butyral (PVB), styrene butadiene rubber (SBR), polyamide-imide, ethylene-vinyl acetate, polyimide, poly(acrylic acid) (PAA), poly(ethylene oxide) (PEO), polyacrylonitrile (PAN), alginate, and guar gum.

In the lithium-sulfur battery comprising the binder composition, the binder composition may form a chemical bond with lithium polysulfide, and the chemical bond may be observed as a peak in the range of 490 to 510 cm⁻¹ based on FT-IR analysis.

The present invention provides a method for manufacturing a sulfur cathode of a lithium-sulfur secondary battery, comprising:
(a) preparing a binder solution for the sulfur cathode by dissolving the binder composition for the sulfur cathode of the lithium-sulfur secondary battery according to any one of claims 1 to 12 in an organic solvent;
(b) preparing an electrode mixture by mixing a cathode active material and a conductive material into the binder solution for the cathode; and
(c) coating the electrode mixture on a current collector and then polymerizing it.

In one embodiment of the present invention, in step (b), the electrode mixture may be prepared by mixing, based on 10 parts by weight of the binder composition for the cathode, 70 to 90 parts by weight of the cathode active material; and 5 to 20 parts by weight of the conductive material.

In one embodiment of the present invention, in step (c), the polymerization may be performed by thermal polymerization at a temperature of 50 to 80° C.

In one embodiment of the present invention, there is provided a lithium-sulfur secondary battery comprising the sulfur cathode for a lithium-sulfur secondary battery.

In one embodiment of the present invention, there are provided a portable electronic device, a mobility unit, a power device, and an energy storage system comprising the lithium-sulfur secondary battery.

The means for solving the above problems do not enumerate all the features of the present invention and may be combined with some embodiments described in this specification. Various features of the present invention and the advantages and effects thereof can be understood in more detail with reference to the following detailed description.

The present invention, through ion dipole interaction-based polar-ionic binder design, enables the binder component of the sulfur cathode to have electrostatic interaction with lithium polysulfide, thereby suppressing the shuttle phenomenon, and induces a three-dimensional morphology of lithium sulfide, the final discharge product, on the surface of the sulfur cathode, thus enabling the implementation of a sulfur cathode with high specific capacity and long cycle life characteristics.

In addition, through dipole-ion interaction, the rheological behavior of the electrode slurry can be controlled, enabling the fabrication of a high-loading sulfur cathode, and as a result, a high-energy density lithium-sulfur secondary battery can be manufactured.

In addition to the above-described effects, the specific effects of the present invention will be described together with the following detailed description for carrying out the invention. Furthermore, the effects of the present invention are not limited to those mentioned above and can be readily realized by the means and combinations described in the specification.

### BRIEF DESCRIPTION OF THE DRAWINGS

FIG. 1 is a conceptual diagram of a binder for a sulfur cathode of a lithium-sulfur secondary battery according to an embodiment, and a sulfur cathode to which it is applied.

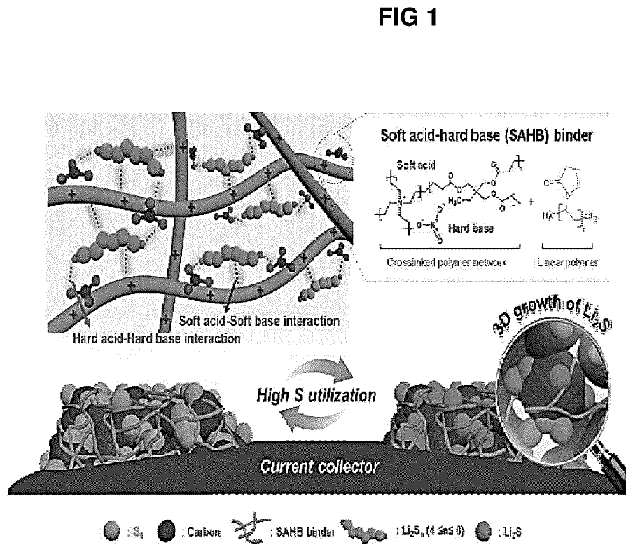

FIG. 2 shows the results of polysulfide shuttle current measurement according to Experimental Example 1.

FIG. 3 is an SEM image of the morphology of lithium sulfide deposited after discharge on the sulfur cathode of Example 1 according to Experimental Example 2.

FIG. 4A shows potentiostatic discharge profile and FIG. 4B shows dimensionless current-time transient according to Experimental Example 3.

FIG. 5A shows charge/discharge profiles and FIG. 5B shows cycle life performance results according to Experimental Example 4.

FIG. 6 shows the cycle life performance results depending on sulfur cathode loading according to Experimental Example 5.

FIG. 7 shows the interaction characteristics between the binder and polysulfide for each binder type according to Experimental Example 6.

In this specification, a numerical range expressed using the term ‘to’ indicates a range of numerical values that includes both the lower limit and the upper limit as specified before and after the term. For example, when ‘a to b’ is described in the specification, it is to be understood as meaning ‘a or more and b or less (a-b)’.

In this specification, when multiple numerical values are disclosed as the upper and lower limits of a certain numerical range, the numerical range disclosed in this specification can be understood as any numerical range in which one of the plurality of lower limit values and one of the plurality of upper limit values are selected as the lower limit and upper limit, respectively. For example, if ‘not less than a’ or ‘not less than b’, and ‘not more than c’ or ‘not more than d’ are described, it can be understood as meaning ‘a to c’, ‘a to d’, ‘b to c’, or ‘b to d’.

Hereinafter, the binder composition for the sulfur cathode of the lithium-sulfur secondary battery of the present invention will be described.

The binder composition for the sulfur cathode of the lithium-sulfur secondary battery of the present invention is characterized by comprising at least one selected from polar monomers, ionic monomers, polar polymers, and ionic polymers, and comprising a counterion that forms a pair with the ion included in the ionic monomer and the ionic polymer.

The ionic monomer or ionic polymer may be cationic, anionic, or zwitterionic.

According to one embodiment of the present invention, the ionic monomer or ionic polymer preferably includes a cationic group and a counter anion that forms a pair with the cationic group.

In this case, the cationic group may be any one selected from the group consisting of an ammonium group, an imidazolium group, a pyridinium group, a phosphonium group, a sulfonium group, a pyrrolidinium group, a guanidinium group, an isothiouronium group, a thiouronium group, a piperidinium group, a methanium group, and a morpholinium group.

In addition, the counter anion may be any one selected from the group consisting of NO₃⁻, BF₄⁻, B(CN)₄⁻, CH₃BF₃⁻, CH₂CHBF₃⁻, CF₃BF₃, C₂F₅BF₃⁻, n-C₃F₇BF₃⁻, n-C₄F₉BF₃⁻, PF₇⁻, CF₃CO₂⁻, CF₃SO₃⁻, N(SO₂CF₃)₂⁻ (TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

According to another embodiment of the present invention, it is preferable that the cationic group is a conjugate base of a soft acid, and the counter anion is an anion that is a conjugate acid of a hard base, forming a combination of soft acid and hard base (hereinafter referred to as SAHB type). In the case of having such a combination, it is highly suitable for inducing three-dimensional lithium sulfide growth on the surface of the sulfur cathode due to strong interaction with lithium polysulfide.

According to another embodiment of the present invention, the ionic monomer may be an ionic monomer comprising an ammonium group represented by the following Structural Formula 1. Here, it is preferable that the counter anion is an anion which is a conjugate acid of a hard base.

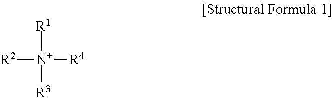

In Structural Formula 1, R¹ to R⁴ are each independently a C1 to C10 alkyl group or a C2 to C10 alkenyl group. More preferably, the ionic monomer represented by Structural Formula 1 may be represented by the following Structural Formula 1-1. Here, it is preferable that the counter anion is an anion which is a conjugate acid of a hard base.

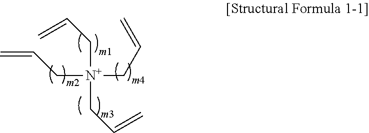

In Structural Formula 1-1, m1 to m4 are the number of repeating units and are each independently an integer from 1 to 10. More preferably, in Structural Formula 1-1, m1 to m4 are the number of repeating units and are each independently an integer from 1 to 4.

Most preferably, the ionic monomer represented by Structural Formula 1-1 is represented by the following Chemical Formula 1, that is, tetraallyl ammonium nitrate, which is a combination of a tetraallyl ammonium cationic monomer and its counter anion, a nitrate ion.

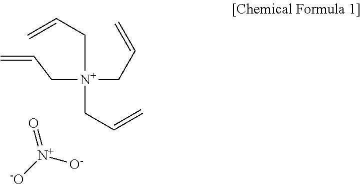

In the case of such a combination of the ionic monomer and nitrate ion, it may be advantageous for suppressing the shuttle phenomenon of lithium polysulfide, and may be more advantageous for forming lithium sulfide with a three-dimensional morphology on the surface of the sulfur cathode.

According to another embodiment of the present invention, the ionic polymer may be a polymer of the ionic monomer or a graft polymer comprising the ionic monomer.

According to another embodiment of the present invention, the binder composition for the sulfur cathode of the lithium-sulfur secondary battery of the present invention may include an ionic polymer in which one or more ammonium groups represented by the following Structural Formula 2 are included in the main chain. In this case, it is preferable that the counter anion forming a pair with the ammonium group is an anion which is a conjugate acid of a hard base, and more preferably, the nitrate ion (NO₃⁻).

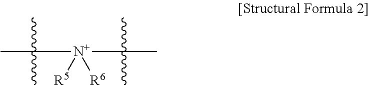

In Structural Formula 2, R⁵ and R⁶ are each independently a C1 to C10 alkyl group or a C2 to C10 alkenyl group.

More preferably, in Structural Formula 2, R⁵ and R⁶ may each independently be a C₁ to C₄ alkyl group or a C₂ to C₄ alkenyl group.

In the case of such a combination of the ionic polymer and nitrate ion, it may be advantageous for suppressing the shuttle phenomenon of lithium polysulfide, and may be more advantageous for forming lithium sulfide with a three-dimensional morphology on the surface of the sulfur cathode.

According to another embodiment of the present invention, it is preferable that the binder composition for the sulfur cathode of the lithium-sulfur secondary battery further includes a crosslinking monomer.

The crosslinking monomer, as a substance for assisting crosslinking, may be selected from commonly used compounds such as acrylic-based, conjugated diene-based, alkene-based, diol-based, fatty acid-based, amino acid-based, hydroxy acid-based, ester-based, lactone-based, carbonate-based, cyclic ether-based, lactam-based compounds, or derivatives thereof.

Preferably, the crosslinking monomer may be selected from ETPTA (ethoxylated trimethylolpropane triacrylate), TMPTA (trimethylolpropane triacrylate), di(trimethylolpropane) tetraacrylate, diethylene glycol diacrylate, diethylene glycol dimethacrylate, ethylene glycol dimethacrylate, dipropylene glycol dimethacrylate, ethylene glycol divinyl ether, diethylene glycol divinyl ether, triethylene glycol dimethacrylate, dipentaerythritol pentaacrylate, trimethylolpropane, trimethylolpropane trimethacrylate, propoxylated trimethylolpropane triacrylate, trimethylolpropane triacrylate, PETA (pentaerythritol triacrylate), PEGDA (poly(ethylene glycol) diacrylate), PEGDMA (poly(ethylene glycol) dimethacrylate), PPGDA (poly(propylene glycol) diacrylate), and PPGDMA (poly(propylene glycol) dimethacrylate).

According to another embodiment of the present invention, it is preferable that the binder composition for the sulfur cathode of the lithium-sulfur secondary battery further includes a linear polymer.

By additionally using the linear polymer, the adhesiveness of the sulfur cathode binder can be further improved.

The linear polymer may be a commonly used electrode binder polymer such as polyvinylpyrrolidone (PVP), polyvinylidene fluoride (PVDF), polytetrafluoroethylene (PTFE), carboxymethylcellulose (CMC), polyvinyl alcohol (PVA), polyvinyl butyral (PVB), styrene butadiene rubber (SBR), polyamide-imide, ethylene-vinyl acetate, polyimide, poly(acrylic acid) (PAA), poly(ethylene oxide) (PEO), polyacrylonitrile (PAN), alginate, and guar gum.

Meanwhile, according to another embodiment of the present invention, the present invention provides a cathode for a lithium-sulfur battery comprising the binder composition, and the binder composition may form a chemical bond with lithium polysulfide. In this case, the chemical bond may mean that a peak is observed in the range of 490 to 510 cm⁻ based on FT-IR analysis.

As the binder composition of the present invention strongly interacts with polysulfide and forms a chemical bond, a sulfur-containing peak may appear in FT-IR analysis, and thereby, the interaction between the binder composition and polysulfide can be demonstrated. As the binder composition of the present invention interacts with polysulfide and forms a chemical bond, it can induce the growth of three-dimensional lithium sulfide on the surface of the sulfur cathode, and thereby, the lithium polysulfide shuttle can be suppressed.

Hereinafter, a method for manufacturing the sulfur cathode of the lithium-sulfur secondary battery of the present invention will be described.

First, the binder composition for the sulfur cathode of the lithium-sulfur secondary battery is dissolved in an organic solvent to prepare a binder solution for the sulfur cathode (step a).

The organic solvent may be selected from N-methyl-2-pyrrolidone (NMP), dimethylformamide (DMF), tetrahydrofuran (THF), dimethyl sulfoxide (DMSO), chloroform, and the like; however, the scope of the present invention is not limited thereto, and any solvent that can dissolve the binder composition for the sulfur cathode to prepare a slurry for electrode coating and is industrially usable may be used.

Next, a cathode active material and a conductive material are mixed into the binder solution for the cathode to prepare an electrode mixture (step b).

The cathode active material may be any one selected from sulfur (S), sulfur-carbon (S-C) composites, SPAN (sulfurized polyacrylonitrile), sulfur-metal oxide composites, sulfur-metal sulfide composites, sulfur-metal compound composites, sulfur-conductive polymer composites, and sulfur-polyaniline composites; however, the scope of the present invention is not limited thereto, and various cathode active materials used in lithium-sulfur secondary batteries may be applied.

The conductive material may include particulate carbon-based conductive materials, fibrous carbon-based conductive materials, plate-shaped carbon-based conductive materials, metal fibers, metal powders, and conductive metal oxides. The particulate carbon-based conductive material may be any one selected from acetylene black, Ketjen black, channel black, furnace black, lamp black, thermal black, and carbon black. The fibrous carbon-based conductive material may be any one selected from carbon nanotubes and conductive carbon fibers. The plate-shaped carbon-based conductive material may be graphene. The conductive material is not limited to the above and any conductive material commonly used for sulfur cathodes in lithium-sulfur secondary batteries may be applied.

Preferably, the electrode mixture is prepared by mixing 70 to 90 parts by weight of a cathode active material and 5 to 20 parts by weight of a conductive material, based on 10 parts by weight of the binder composition for the cathode. When the electrode is manufactured with such a composition, adhesion of the electrode material to the current collector is sufficiently achieved, and the suppression of the lithium polysulfide shuttle phenomenon and the formation of a three-dimensional lithium sulfide structure on the surface of the sulfur cathode according to the function of the binder material of the present invention can be effectively achieved. In addition, if the conductive material is included in an amount less than the above range, it is difficult to overcome the low electrical conductivity of sulfur, and if it exceeds the above range, agglomeration of the conductive material may occur or the energy density of the battery may decrease.

Next, the electrode mixture is coated on a current collector and then polymerized (step c).

The current collector may be made of a material such as calcined carbon, stainless steel, aluminum, nickel, or titanium, and the form of the current collector may be foil, net, foam, or nonwoven fabric.

The coating may be performed by a method such as doctor blade, bar coating, screen coating, or gravure coating.

The polymerization is preferably performed by thermal polymerization at 50 to 80° C., and more preferably, thermal polymerization may be carried out at 55 to 70° C. If the temperature is below 50° C., polymerization of the ionic monomer may not occur, and if it exceeds 80° C., unnecessary process costs may be incurred.

The present invention provides a lithium-sulfur secondary battery comprising the sulfur cathode for the lithium-sulfur secondary battery.

The lithium-sulfur secondary battery of the present invention includes the above-described sulfur cathode, an anode comprising lithium metal or a lithium alloy, and a separator positioned between the cathode and the anode, and may include an electrolyte impregnated into the anode, cathode, and separator.

The lithium alloy may be a lithium alloy of Na, K, Rb, Cs, Fr, Be, Mg, Ca, Sr, Ba, Ra, Al, or Sn.

The separator may be a porous polymer film made of a polyolefin-based polymer such as an ethylene homopolymer, a propylene homopolymer, an ethylene/butene copolymer, an ethylene/hexene copolymer, or an ethylene/methacrylate copolymer, or may be a nonwoven fabric such as a glass fiber nonwoven fabric.

The electrolyte may include LiCl, LiBr, LiI, LiClO₄, LiBF₄, LiB₁₀Cl₁₀, LiB(Ph)₄, LiC₄BO₈, LiPF₆, LiCF₃SO₃, LiCF₃CO₂, LiAsF₆, LiSbF₆, LiAlCl₄, LiSO₃CH₃, LiSO₃CF₃, LiSCN, LiC(CF₃SO₂)₃, LiN(CF₃SO₂)₂, LiN(C₂F₅SO₂)₂, LiN(SO₂F)₂, and the like, and preferably, a lithium imide such as LiTFSI may be used.

In addition, the present invention provides a device selected from a portable electronic device, a mobility unit, a power device, and an energy storage system, comprising the lithium-sulfur secondary battery.

Hereinafter, embodiments according to the present invention will be specifically described by way of examples.

### EXAMPLE

### Preparation Example 1: Preparation of Electrode Binder (SAHB Type) for Sulfur Cathode

Tetraallyl ammonium nitrate (TA-NO₃), which is an ionic monomer represented by Chemical Formula 1, was mixed with trimethylolpropane ethoxylate triacrylate (ETPTA), which is a crosslinking monomer, and polyvinylpyrrolidone (PVP), which is a linear polymer, to prepare a SAHB type (Soft Acid-Hard Base type) electrode binder for a sulfur cathode. At this time, PVP:TA-NO₃:ETPTAwere mixed in a weight ratio of 50:33:17 (w/w/w).

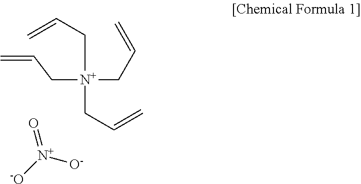

### Preparation Example 2: Preparation of Electrode Binder (SASB Type) for Sulfur Cathode

An electrode binder for a sulfur cathode of SASB type (Soft Acid-Soft Base type) was prepared under the same conditions as in Preparation Example 1, except that tetraallyl ammonium bis(trifluoromethylsulfonyl)amide (TA-TFSI) was used instead of tetraallyl ammonium nitrate (TA-NO₃) as the ionic monomer.

### Example 1: Preparation of Sulfur Cathode (SAHB Type)

The electrode binder prepared according to Preparation Example 1 was dissolved in a process solvent, N-methyl-2-pyrrolidone (NMP), to prepare a 10 wt % binder solution. A slurry of the electrode mixture was prepared by adding a sulfur-carbon (S-C) composite (S/C=8/2 (w/w)) as the cathode active material and a conductive material (carbon, Super P) to the binder solution such that the weight ratio of cathode active material:conductive material:binder solution was 80:10:10.

The electrode mixture slurry prepared as described above was coated onto an aluminum current collector to a thickness of 20 μm using a doctor blade, and then the monomer in the mixture slurry was polymerized while simultaneously drying the process solvent in an oven at 60° C. to prepare the sulfur cathode.

### Example 2: Preparation of Sulfur Cathode (SASB Type)

A sulfur cathode (SASB type) was prepared under the same conditions as in Example 1, except that the electrode binder for the sulfur cathode prepared according to Preparation Example 2 was used instead of the electrode binder prepared according to Preparation Example 1.

### Comparative Example 1: Preparation of Sulfur Cathode (Bare Type)

A sulfur cathode was prepared under the same conditions as in Example 1, except that PVP alone was used instead of the electrode binder for the sulfur cathode prepared according to Preparation Example 1.

### Device Example 1: Preparation of Lithium-Sulfur Secondary Battery (SAHB Type)

A lithium-sulfur secondary battery was prepared using the sulfur cathode prepared according to Example 1, a lithium thin film with a thickness of approximately 150 μm as the anode, a polyolefin film (Celgard® 2500) as the separator, and an electrolyte composed of 1M lithium bis(trifluoromethane)sulfonimide (LiTFSI) in DME (dimethoxyethane):DOL (dioxolane) (1:1 v:v) with 2 wt % LiNO₃.

### Device Example 2: Preparation of Lithium-Sulfur Secondary Battery (SASB Type)

A lithium-sulfur secondary battery was prepared under the same conditions as in Device Example 1, except that the sulfur cathode prepared according to Example 2 was used instead of the sulfur cathode prepared according to Example 1.

### Device Comparative Example 1: Preparation of Lithium-Sulfur Secondary Battery (Bare Type)

A lithium-sulfur secondary battery was prepared under the same conditions as in Device Example 1, except that the sulfur cathode prepared according to Comparative Example 1 was used instead of the sulfur cathode prepared according to Example 1.

### Experimental Example

### Experimental Example 1: Evaluation of Lithium Polysulfide Shuttle Suppression Ability

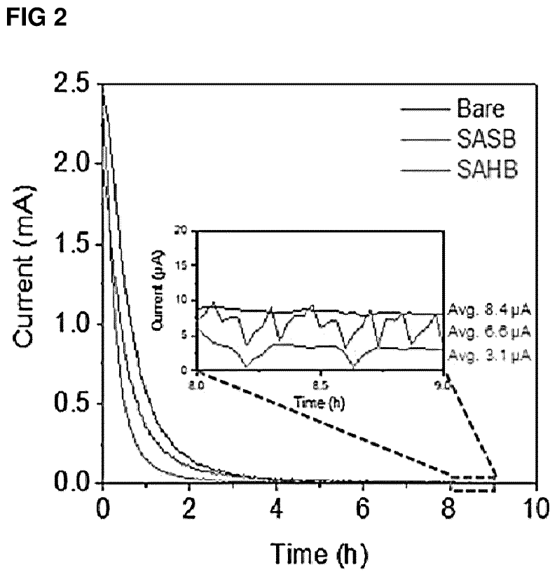

For the lithium-sulfur secondary batteries respectively prepared according to Device Example 1, Device Example 2, and Device Comparative Example 1, lithium polysulfide shuttle current was measured by charging up to 2.7 V, and then applying a constant voltage of 2.38 V to measure the saturation current. The results are shown in FIG. 2.

According to this, it was found that the shuttle current was significantly reduced in the lithium-sulfur secondary battery comprising the sulfur cathode prepared using an ionic polymer-based binder. In addition, Device Example 1, which includes a sulfur cathode based on an SAHB (Soft Acid-Hard Base type) ionic polymer binder, showed a smaller shuttle current compared to Device Example 2, which includes a sulfur cathode based on an SASB (Soft Acid-Soft Base type) ionic polymer binder.

Since the ionic polymer-based binder can interact with lithium polysulfide generated during charge/discharge within the electrode pore structure, it can suppress the lithium polysulfide shuttle. Accordingly, the cycle life characteristics of the sulfur cathode can be improved, and the specific capacity can be increased.

### Experimental Example 2: Identification of Lithium Sulfide Morphology

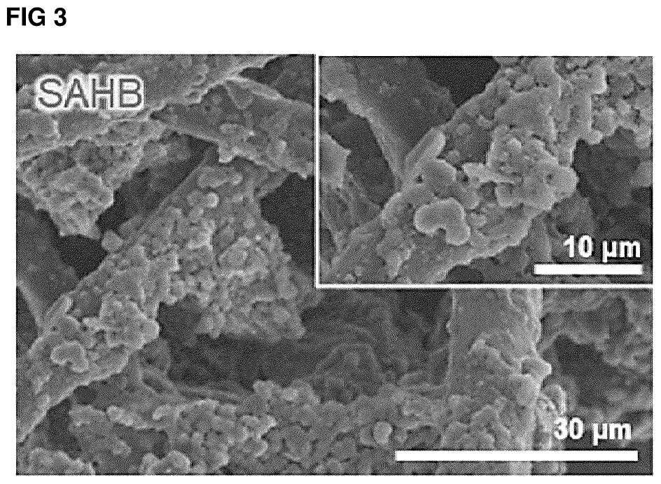

An SEM image of the morphology of lithium sulfide deposited after discharge on the sulfur cathode of the lithium-sulfur battery of Device Example 1 is shown in FIG. 3.

According to this, it can be confirmed that a three-dimensional morphology of lithium sulfide, which is the final discharge product, was well formed on the sulfur cathode. Therefore, it can be seen that a lithium sulfide layer is formed over the entire surface of the sulfur cathode, solving the problem of passivation of the cathode surface. That is, the ionic polymer binder of the present invention not only suppresses the shuttle phenomenon of lithium polysulfide through interaction with lithium polysulfide generated during charge/discharge, but also allows the final discharge product, lithium sulfide, to form a three-dimensional morphology so that the sulfur cathode surface is not completely covered, thereby preventing passivation of the cathode surface.

### Experimental Example 3: Discharge Profile Analysis

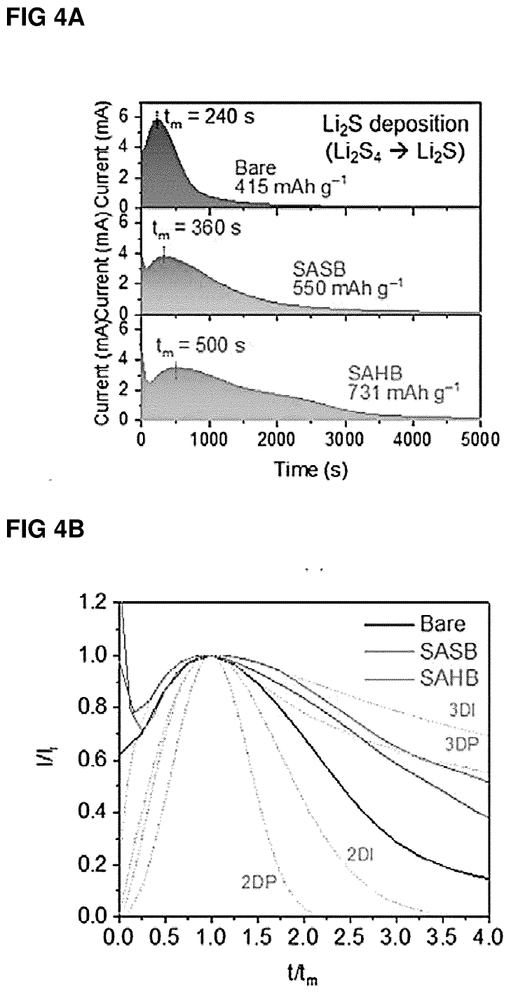

FIG. 4A shows the potentiostatic discharge profiles and FIG. 4B shows the dimensionless current-time transients of the lithium-sulfur secondary batteries respectively prepared according to Device Example 1, Device Example 2, and Device Comparative Example 1.

FIG. 4A shows the potentiostatic discharge profile was performed according to a method in which, after discharging to 2.2 V to remove long-chain polysulfides (Li₂Sₓ, x>4), a constant voltage of 2.05 V was applied to measure the current for the lithium sulfide electrodeposition reaction. Through this, it was found that the peak time (tₘ) was extended in Device Example 1 including the SAHB-type electrode, and since the peak time (tₘ) is related to the cathode passivation rate, it indicates that the SAHB-type binder suppressed passivation of the cathode surface. FIG. 4B shows the dimensionless current-time graph can be fitted to four classical electrochemical deposition models, and it was found that the SAHB-type electrode followed the 3D progressive (3DP) nucleation model, whereas the Bare-type and SASB-type electrodes were located between the 3DP and 2D instantaneous (2D1I) nucleation models. That is, this means that when the SAHB-type binder is applied to the electrode, it can induce three-dimensional lithium sulfide growth.

### Experimental Example 4: Charge/Discharge Profile and Cycle Life Characteristic Analysis

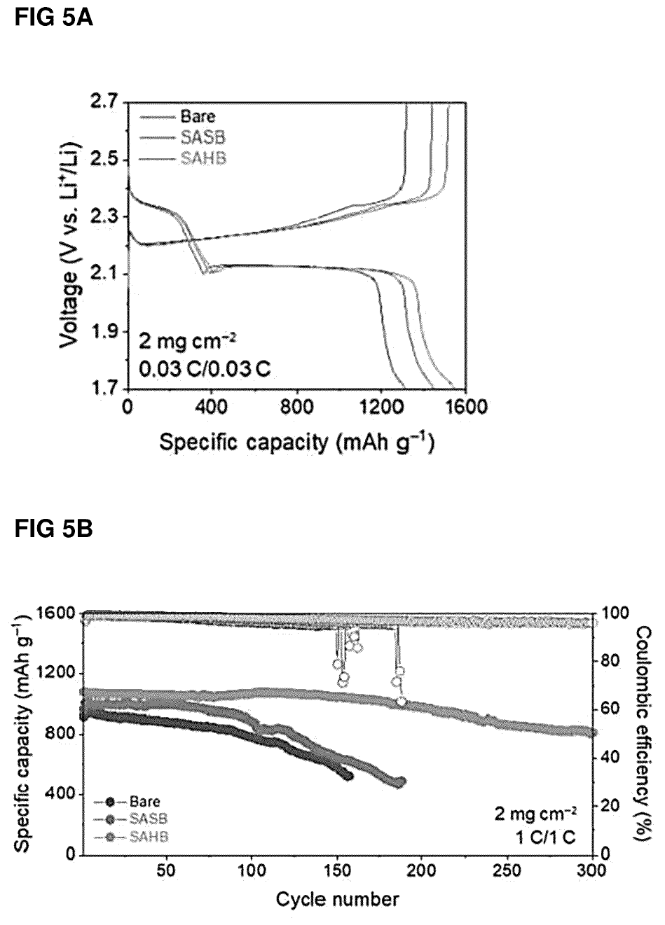

For the lithium-sulfur secondary batteries of Device Example 1 (SAHB), Device Example 2 (SASB), and Device Comparative Example 1 (Bare), constant current charge/discharge tests were performed with the sulfur cathode loading amount set to 2 mg/cm² under 0.03 C/0.03 C conditions, and the cycle life characteristics were evaluated under 1 C/1 C conditions. FIG. 5A shows the charge/discharge profiles and FIG. 5B shows the results of the cycle life characteristic measurements.

According to this, the battery of Device Comparative Example 1 stopped operating at 160 cycles, and the battery of Device Example 2 stopped operating at 190 cycles; however, the battery of Device Example 1 maintained the coulombic efficiency at the initial level even at 300 cycles, and the specific capacity was also maintained at a high level.

### Experimental Example 5: Analysis of Cycle Life Characteristics According to Sulfur Cathode Loading Amount

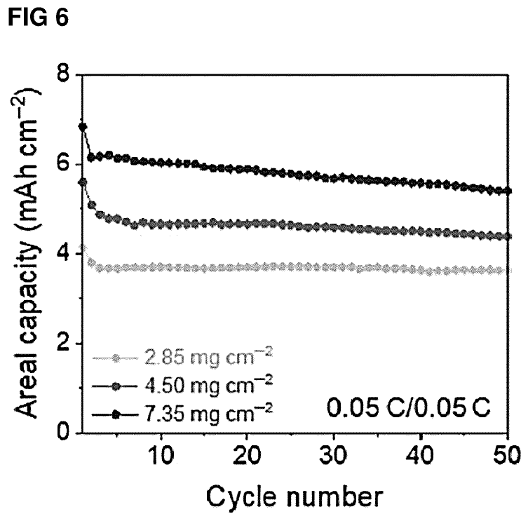

The cycle life characteristics according to the loading amount of the sulfur cathode in Device Example 1 (SAHB) were analyzed under 0.05 C/0.05 C conditions, and the results are shown in FIG. 6. At this time, the loading amounts of the sulfur cathode were varied as 2.85 mg/cm², 4.50 mg/cm², and 7.35 mg/cm² for the analysis of cycle life characteristics.

According to this, it was found that as the loading amount of the sulfur cathode increased, the areal capacity also increased, and the areal capacity was maintained at the same level even after 50 cycles. In particular, in the sulfur cathode with a high loading of 7.35 mg/cm², the areal capacity after 50 cycles remained at a level almost similar to the initial capacity, confirming that the sulfur cathode comprising the ionic crosslinked polymer binder of the present invention enables high loading.

### Experimental Example 6: FT-IR Analysis of Binder Film

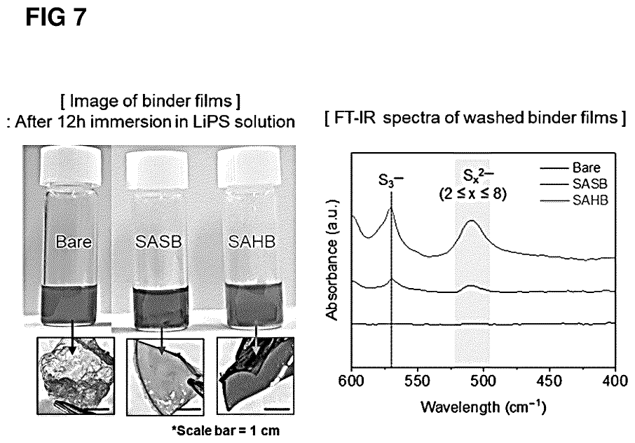

Binder films were prepared using the binders of Preparation Example 1 (SAHB-type binder; TA-NO₃), Preparation Example 2 (SASB-type binder; TA-TFSI), and PVP (Bare), and then immersed in a lithium polysulfide solution for 12 hours and subsequently recovered. Thereafter, the binder films were washed with a DOL/DME=1/1 (v/v) solution, FT-IR analysis was performed on the binder films, and the results are shown in FIG. 7.

Referring to FIG. 7, the binder film comprising the binder of Preparation Example 1 (SAHB-type binder; TA-NO₃) showed the largest peak in the range of 490-510 cm⁻¹, which corresponds to sulfur anions. That is, it can be confirmed that the binder strongly interacts with lithium polysulfide merely by immersing the binder film in lithium polysulfide.

On the other hand, the binder films comprising the binder of Preparation Example 2 (SASB-type binder; TA-TFSI) and PVP (Bare) showed almost no peak in the range of 490-510 cm⁻¹, indicating that the interaction with polysulfide is relatively weak.

As described above, since the binder of the present invention strongly interacts with polysulfide, it can induce the growth of three-dimensional lithium sulfide on the surface of the sulfur cathode by the polysulfide, and can suppress the lithium polysulfide shuttle.

While the embodiments of the present invention have been described above, it will be apparent to those of ordinary skill in the art that various modifications and changes can be made to the present invention without departing from the spirit of the present invention as set forth in the claims, such as addition, modification, deletion, or supplementation of components, and such modifications and changes are also included within the scope of the present invention.

What is claimed is:

1. A binder composition for a sulfur cathode of a lithium-sulfur secondary battery,
comprising at least one selected from an ionic monomer, an ionic polymer, a polar monomer, and a polar polymer,
and comprising a counterion that forms a pair with an ion included in the ionic monomer and the ionic polymer.

2. The binder composition for a sulfur cathode of a lithium-sulfur secondary battery according to claim 1,
wherein the ionic monomer or the ionic polymer comprises a cationic group and a counter anion that forms a pair with the cationic group,
the cationic group being any one selected from the group consisting of an ammonium group, an imidazolium group, a pyridinium group, a phosphonium group, a sulfonium group, a pyrrolidinium group, a guanidinium group, an isothiouronium group, a thiouronium group, a pyrimidinium group, a methanium group, and a morpholinium group,
and the counter anion being any one selected from the group consisting of NO₃⁻, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₇⁻, CF₃CO₂⁻, CF₃SO₃⁻, N(SO₂CF₃)₂⁻ (TFSI⁻), N(COCF₃)(SO₂CF₃)⁻, N(SO₂F)₂⁻, N(CN)₂⁻, C(CN)₃⁻, SCN⁻, SeCN⁻, CuCl₂⁻, and AlCl₄⁻.

3. The binder composition for a sulfur cathode of a lithium-sulfur secondary battery according to claim 2,
wherein the cationic group is a conjugate base of a soft acid, and the counter anion is an anion which is a conjugate acid of a hard base, forming a combination of soft acid and hard base (SAHB type).

4. The binder composition for a sulfur cathode of a lithium-sulfur secondary battery according to claim 3,
wherein the ionic monomer is an ionic monomer comprising an ammonium group represented by the following Structural Formula 1: 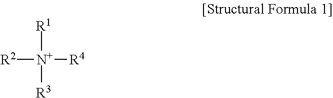
In Structural Formula 1,
R¹ to R⁴ are each independently a C1 to C10 alkyl group or a C2 to C10 alkenyl group.

5. The binder composition for a sulfur cathode of a lithium-sulfur secondary battery according to claim 4,
wherein the ionic monomer represented by Structural Formula 1 is represented by the following Structural Formula 1-1: 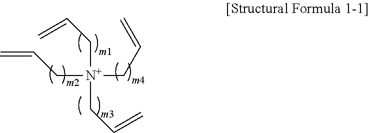
In Structural Formula 1-1,
m1 to m4 are the number of repeating units and are each independently an integer from 1 to 10.

6. The binder composition for a sulfur cathode of a lithium-sulfur secondary battery according to claim 5,
wherein the ionic monomer and its counter anion are tetraallyl ammonium and nitrate ion (NO₃⁻), represented by the following Chemical Formula 1:

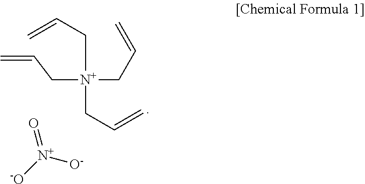

7. The binder composition for a sulfur cathode of a lithium-sulfur secondary battery according to claim 2,
wherein the ionic polymer is a polymer of the ionic monomer or a graft polymer comprising the ionic monomer.

8. The binder composition for a sulfur cathode of a lithium-sulfur secondary battery according to claim 7,
wherein the ionic polymer comprises one or more ammonium groups represented by the following Structural Formula 2 in the main chain,
and the counter anion that forms a pair with the ammonium group is an anion which is a conjugate acid of a hard base: 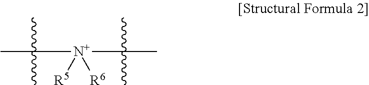
In Structural Formula 2,
R⁵ and R⁶ are each independently a C1 to C10 alkyl group or a C2 to C10 alkenyl group.

9. The binder composition for a sulfur cathode of a lithium-sulfur secondary battery according to claim 1,
wherein the binder composition further comprises a crosslinking monomer.

10. The binder composition for a sulfur cathode of a lithium-sulfur secondary battery according to claim 9,
wherein the crosslinking monomer is any one selected from the group consisting of ethoxylated trimethylolpropane triacrylate (ETPTA), trimethylolpropane triacrylate (TMPTA), di(trimethylolpropane) tetraacrylate, diethylene glycol diacrylate, diethylene glycol dimethacrylate, ethylene glycol dimethacrylate, dipropylene glycol dimethacrylate, ethylene glycol divinyl ether, diethylene glycol divinyl ether, triethylene glycol dimethacrylate, dipentaerythritol pentaacrylate, trimethylolpropane, trimethylolpropane trimethacrylate, propoxylated trimethylolpropane triacrylate, trimethylolpropane triacrylate, pentaerythritol triacrylate (PETA), poly(ethylene glycol) diacrylate (PEGDA), poly(ethylene glycol) dimethacrylate (PEGDMA), poly(propylene glycol) diacrylate (PPGDA), and poly(propylene glycol) dimethacrylate (PPGDMA).

11. The binder composition for a sulfur cathode of a lithium-sulfur secondary battery according to claim 1,
wherein the binder composition further comprises a linear polymer.

12. The binder composition for a sulfur cathode of a lithium-sulfur secondary battery according to claim 11,
wherein the linear polymer is any one selected from the group consisting of polyvinylpyrrolidone (PVP), polyvinylidene fluoride (PVDF), polytetrafluoroethylene (PTFE), carboxymethylcellulose (CMC), polyvinyl alcohol (PVA), polyvinyl butyral (PVB), styrene butadiene rubber (SBR), polyamide-imide, ethylene-vinyl acetate, polyimide, poly(acrylic acid) (PAA), poly(ethylene oxide) (PEO), polyacrylonitrile (PAN), alginate, and guar gum.

13. A lithium-sulfur battery comprising the binder composition according to claim 1,
wherein the binder composition forms a chemical bond with lithium polysulfide,
and the chemical bond is observed as a peak in the range of 490 to 510 cm⁻¹ based on FT-IR analysis.

14. A method for manufacturing a sulfur cathode of a lithium-sulfur secondary battery, comprising:
(a) dissolving the binder composition for a sulfur cathode of a lithium-sulfur secondary battery according to claim 1 in an organic solvent to prepare a binder solution for the sulfur cathode;
(b) mixing a cathode active material and a conductive material into the binder solution for the cathode to prepare an electrode mixture; and
(c) coating the electrode mixture on a current collector and then polymerizing it.

15. The method for manufacturing a sulfur cathode of a lithium-sulfur secondary battery according to claim 14,
wherein, in step (b), the electrode mixture is prepared by mixing 50 to 90 parts by weight of a cathode active material and 5 to 20 parts by weight of a conductive material, based on 1 to 10 parts by weight of the binder composition for the cathode.

16. The method for manufacturing a sulfur cathode of a lithium-sulfur secondary battery according to claim 14,
wherein, in step (c), the polymerization is performed by thermal polymerization at a temperature of 50 to 80° C.

17. A lithium-sulfur secondary battery comprising the sulfur cathode manufactured according to the method of claim 14.

18. A device selected from a portable electronic device, a mobility unit, a power device, and an energy storage system, comprising the lithium-sulfur secondary battery according to claim 17.
